(19) United States
(12) Patent Application Publication
(10) Pub. No.: US 2012/0257934 A1
(43) Pub. Date: Oct. 11, 2012

(54) METERING SYSTEM, DENSE PHASE CONVEYING SYSTEM AND METHOD FOR SUPPLYING BULK MATERIAL IN POWDER FORM

(75) Inventors: Horst Kretschmer, Weissenborn (DE); Jörg Kleeberg, Freiberg (DE); Dietmar Rüger, Bannewitz-Goppeln (DE); Olaf Schulze, Tuttendorf (DE); Christian Eichhorn, Freiberg (DE)

(73) Assignee: LINDE AG

(21) Appl. No.: 13/500,364

(22) PCT Filed: Oct. 8, 2010
(86) PCT No.: PCT/EP2010/006149

§ 371 Date: Jun. 25, 2012

(30) Foreign Application Priority Data
Oct. 10, 2009 (DE) 102009048.931.2

(51) Int. Cl. B65G 51/08

(52) U.S. Cl. 406/14

(57) ABSTRACT

The present invention relates to a metering system for the steady, continuous, dosed supply of a bulk material in powder form made of light, polydisperse particles from a supply device (B, SG) into a plurality of conveying tubes (FR1, FR2, FR3) to a consumer arranged downstream. The metering system comprises at least two metering containers (DB1, DB2, DB3) each having a delivery device (AE2/1, AE2/2, AE2/3), the delivery device (AE2/1, AE2/2, AE2/3) for each of the conveying tubes (FR1, FR2, FR3) comprising a dust flow regulation device (FI1/1, FI2/1, FI3/2), which is assigned thereto and opens therein, and a mass flow measuring probe (FIC1, FIC2, FIC3) being arranged on each of the conveying tubes (FR1, FR2, FR3), which is coupled to the dust flow regulation device (FI1/1 to FI3/2) which opens into the corresponding conveying tube (FR1, FR2, FR3). Furthermore, the metering system has a pressure regulation device, which is coupled to the pressure measuring devices (PI1/1, PI1/2, PI1/3) arranged on the delivery devices (AE2/1, AE2/2, AE2/3), and which controls a metering container pressure (PIS2/1, PIS2/2, PIS2/3) at least as a function of a metering container fill level (LIS1, LIS2, LIS3). A pump device (V) can be coupled to each of the metering containers (DB1, DB2, DB3), which provides a pressure (PIS2/1, PIS2/2, PIS2/3) in the metering container (DB1, DB2, DB3), which is less than a pressure in the supply device (B, SG). Furthermore, the invention discloses a dense phase conveying system, which comprises the metering system and a method for the steady, continuous, dosed supply of a bulk material in powder form made of light, polydisperse particles.

The following invention relates to a metering system and a dense phase conveying system for the steady, continuous, dosed supply of a bulk material in powder form made of light, polydisperse particles to a consumer arranged downstream. Furthermore, the invention relates to a method for the continuous, dosed supply of the bulk material in powder form using a dense phase conveying system, which comprises the metering system according to the invention.

Pneumatic thin phase and dense phase conveying systems are used for the supply of pulverized fuel in entrained flow gasification reactors or other consumer or reactor systems such as blast furnaces, cupola furnaces, etc. A system configuration made of bunkers, (air)locks, metering containers, and typically parallel conveying tubes, which lead from the metering container to multiple dust burners, has prevailed. The mass flow regulation is performed by means of the differential pressure between the metering container and the consumer. The total mass flow is ascertained by means of a weighing system on the metering container, the mass flows in the individual conveying tubes are determined from individual measurements of the flow density and the flow speed. Deviations of individual conveying tubes from the proportional total mass flow are corrected by auxiliary gas feed into the conveying tube. Such pulverized fuel supply systems, which are suitable for bulk materials having bulk densities greater than 450 kg/m³, are described, for example, in DE 28 31 208, DE 32 11 045, DD 268 835, DE 10 2005 047 583, DD 139 271 and by K. Scheidig et al. in “Neue Hütte [New Metallurgy]” Leipzig, December 1983, pages 441-442.

However, the continuous supply of dusts having bulk densities less than 450 kg/m³ is not possible or is only possible to a limited extent using the methods known from the prior art. Such light dusts, which are polydisperse with respect to the particle shape, arise upon the thermal pretreatment of renewable fuels, which are already light per se. The renewable fuels, such as wood, hay, and other biomasses, decompose upon thermal pretreatment (spontaneous drying, degasification, splitting) or upon hydrothermal carbonization of biomasses into manifold shapes, and acquire a porous structure. Both effects have the result that the dusts of these fuels have bulk density values of 150 to 400 (450) kg/m³ and void volumes of up to 94% of the bulk volume. The gross density decreases in relation to the true density (gross density of 200 to 800 kg/m³, true density of 800 to 2,500 kg/m³). When they flow out of containers such as a bunker or metering containers, these light dusts no longer follow the gravity flow, they form wedges and only have a very slight flowability. Fluidization results in strong swirling and blowing away of this dust in front of the outlet openings and in strong dilution effects, and therefore even in actual gas breakthroughs in the final effect.

Proceeding from this prior art, the present invention is based on the object of providing a metering system, using which continuous, dosed supply of such a bulk material in powder form made of light, polydisperse particles is possible, independently of the reaction pressure which prevails in a consumer arranged downstream.

Such a metering system is disclosed by the features of Claim 1.

A dense phase conveying system, which achieves the object of the steady, continuous, dosed supply of the light dust from a supply device, from which the bulk material originates, to the consumer, is provided by the dense phase conveying system having the features of Claim 9.

Further embodiments of the respective devices are disclosed in the subclaims.

The object of providing a corresponding method for the steady, continuous, dosed supply of a bulk material in powder form made of light, polydisperse particles is achieved by a method having the features of Claim 13.

A first embodiment of a metering system according to the invention, which is suitable for the steady, continuous, dosed supply of a bulk material in powder form made of light, polydisperse particles from a supply device into a plurality of conveying tubes to a consumer arranged downstream is directed to the fact that this metering system comprises two or more metering containers, which are each equipped with a delivery device. Each of the delivery devices has a dust flow regulation device assigned thereto for each of the conveying tubes, so that in each case a dust flow regulation device of each delivery device opens into one of the conveying tubes. A mass flow measuring probe arranged in each of the conveying tubes is coupled to each of the dust flow regulating devices of the delivery devices, which opens into the corresponding conveying tube. The metering system is additionally equipped with a pressure regulation device, which is coupled to pressure measuring devices, which are each located in the area of the delivery devices of the metering containers. The metering container pressure of the respective metering container is controlled by the pressure regulation device, a first control parameter being the respective metering container fill level. For this purpose, the pressure regulation device is coupled to a corresponding measuring device for the metering container fill level. To be able to fill the metering container with the light, polydisperse bulk material, a forced flow is generated from the supply device to the metering container, in that, as a function of the fill level, a pump device such as a blower or a ventilator is connected to the metering container to be filled and generates a pressure in the metering container which is lower than a pressure in the supply device.

The main control parameters for the metering container pressure are the total mass flow to the consumer and the consumer pressure prevailing therein. The pressure difference between the conveying metering container and the consumer determines the level of the total mass flow through the conveying tubes. The metering container pressure, which is therefore primarily to be regulated, results from the sum of the consumer pressure and the differential pressure, which determines the total mass flow. The pressure regulation device is therefore coupled to the mass flow measuring probe, a measuring device for the total mass flow, for example, a weighing system of the metering container, and a pressure measuring device of the consumer. The metering container pressure for conveying the bulk material in the conveying tubes is controlled via supply or removal of gas into or from the metering container by the pressure regulation device, in that a plurality of regulating and shutoff valves in a pressurization gas line, a depressurization gas line, and a swirl gas line is controlled by the pressure regulation device. Pressure variations due to the variable fill level of the metering container are eliminated in that the pressure measuring device for the metering container pressure is arranged below the dust bulk fill in the delivery device.

In a further embodiment of the invention, each two metering containers of the metering system may be connected to one another via a pressure equalization line, which may be opened or closed by closing devices. The closing devices may be actuated in a manner controlled by the metering container pressure and metering container fill level.

The closing devices in the pressure equalization line, the dust flow regulation devices having assigned closure devices of the first metering container, and the dust flow regulation devices having assigned closing devices of the second metering container are operatively coupled to one another for this purpose via a control device, so that the mass flow in each of the conveying tubes can be kept constant as a function of the metering container fill levels of the two connected metering containers. This control device can simultaneously actuate the closing devices and the dust flow regulation devices of the two connected metering containers, the dust flow regulation devices of the two coupled metering containers being actuated depending on the actuation, which is controlled by the metering container pressure or the metering container fill level, of the closing devices. These dust flow regulation devices are activated in such a manner that the mass flows in the conveying tubes are maintained constantly. This is performed by an adapted actuation of the dust flow regulation devices of the first metering container with the dust flow regulation devices of the second metering container, in particular by the adapted actuation of those dust flow regulation devices of the first and second metering containers which lead into the same conveying line.

In order to assist the delivery of the light dust from the metering containers into the conveying tubes, the delivery devices each comprise a swirl base (fluidized bed) and a stirring device arranged above the swirl base (fluidized bed). The swirl gas lines each open below the swirl base into the corresponding delivery device. In addition to the dust flow regulation devices, the delivery devices comprise closure devices, which are each assigned to one dust flow regulation device. In addition, the dust flow regulation devices are coupled to measuring devices for the respective metering container fill levels, to the respective metering container pressure measuring devices, and in each case to a measuring device for determining the total mass flow, for example, a weighing system.

A preferred dust flow regulation device can have a smooth and wear-resistant flow channel having an adjustable flap, which may be actuated by a fine actuator, so that the flow channel cross-section decreases continuously downstream in the direction of the conveying tubes.

An opening of the pressurization gas line and, under certain circumstances, also the one of a compensation gas line into the metering container for its pressure regulation can be arranged horizontally above the swirl base so that an introduction of the pressurization gas or the compensation gas, respectively, can occur diffusely distributed.

Dusts which may be supplied in a dosed manner using the metering system according to the invention are light, polydisperse particles having a void volume in a range up to 94%, which have a gross density of 200 to 800 kg/m³ (which corresponds to a bulk density of 150 to 200/450 kg/m³).

A further object of the invention is a dense phase conveying system, which, in addition to the metering system according to the invention, comprises a supply device, and the conveying tubes to the consumer arranged downstream. According to the invention, the comprised metering system consists of at least two coupled metering containers; depending on the required metering performance, however, more than two metering containers may also be arranged and coupled to one another accordingly. The supply device comprised by the dense phase conveying system can be a bunker in one embodiment, in a further embodiment, the supply device can be a central supply system, in which the filling of the metering containers occurs directly from a central repository, such as a dryer, carbonization plant, or degasser, pneumatically or mechanically. The supply can also occur pneumatically or mechanically from a bunker.

A bunker according to one embodiment of the invention comprises a ventilation element, for ventilating the bunker bulk fill, and multiple bunker delivery elements, which correspond to the number of the metering containers arranged downstream. The bunker delivery elements are connected via a shutoff valve and a filling line to one metering container each. Each metering container is additionally closable in relation to the supply device by a closure device. A suitable shutoff valve, which can also be arranged in the filling lines of the central supply system, can be a rotary valve, a Y-type valve, or preferably a butterfly valve (a rotary shutter).

The dense phase conveying system has a ventilator device, which can be connected to the metering containers and can be actuated in a manner controlled by the metering container fill level. The ventilator device is designed in such a manner that it can provide a partial vacuum in the respective metering container in relation to the pressure in the supply device.

A method according to the invention relates to the steady, continuous, dosed supply of the bulk material in powder form made of light, polydisperse particles by the dense phase conveying system according to the invention, which comprises a supply device, a metering system according to the invention, and multiple conveying tubes, which lead to a consumer arranged downstream. The steady, continuous, dosed supply is provided by coupled, adapted operation of the two or more metering containers of the metering system, in that a partial vacuum is applied, controlled by the fill level, to the individual metering containers, when they are empty, in relation to the supply device for the filling with bulk material from the supply device, and an operating pressure is applied to the metering containers using pressurization gas upon a fill level maximum. If a metering metering container, from which the dust is supplied into the conveying tubes, reaches a fill level minimum, i.e., shortly before it runs empty, the coupled, adapted operation of the metering system, which is controlled by the fill level, causes the sliding connection of a second metering container, which, while filled with bulk material to a fill level maximum, is pressurized to operating pressure, in that the emptying first metering container is connected via the pressure equalization line to the second full metering container, while the dust flow regulation devices of the first metering container end the conveyance in the conveying tubes, and simultaneously the dust flow regulation devices of the second metering container are opened in an adapted manner by the control device. Thus, upon signaling of the fill level minimum of the metering container by the control device, the pressure equalization line to a full metering container, which is pressurized to operating pressure, is opened, and upon prevailing pressure equalization of both metering containers, the respective dust flow regulation devices are closed or opened, so that the mass flow remains constant in the respective conveying tubes. This sliding change of the metering container advantageously runs automatically in a manner controlled by the fill level, pressure, and mass flow, without the dust supply being interrupted or occurring irregularly.

The dense phase conveying system according to the invention having the metering system therefore advantageously offers the omission of (air)locks and therefore a substantial source of irregularities and possible disturbances. In addition, the steady dust flow from the bunker to the metering container and at the delivery devices to the conveying tubes is caused by forced flow forces, because the gravity flow is inadequate due to the low bulk/gross density values of the light particles. Furthermore, large entry or exit cross-sections, and therefore large and expensive high-pressure closure devices, on the bunker and on the metering containers are omitted because of the use of the flow forces. The time demand for the work steps of the metering unit is decreased due to the elemination of the (air)lock actions, while simultaneously the metering container conveyance is advantageously not disturbed by refilling the (air)locks. Instead, the change of the conveying metering containers, which are equipped with an increased number of dust flow regulation devices, offers the advantageous steady, continuous, dosed supply of the light bulk material dust.

These and further advantages are illustrated by the following description with reference to the appended figures.

The reference to the figures in the description is used to assist the description. Objects or parts of objects which are essentially identical or similar may be provided with the same reference signs. The figures are solely schematic illustrations of exemplary embodiments of the invention. In the figures:

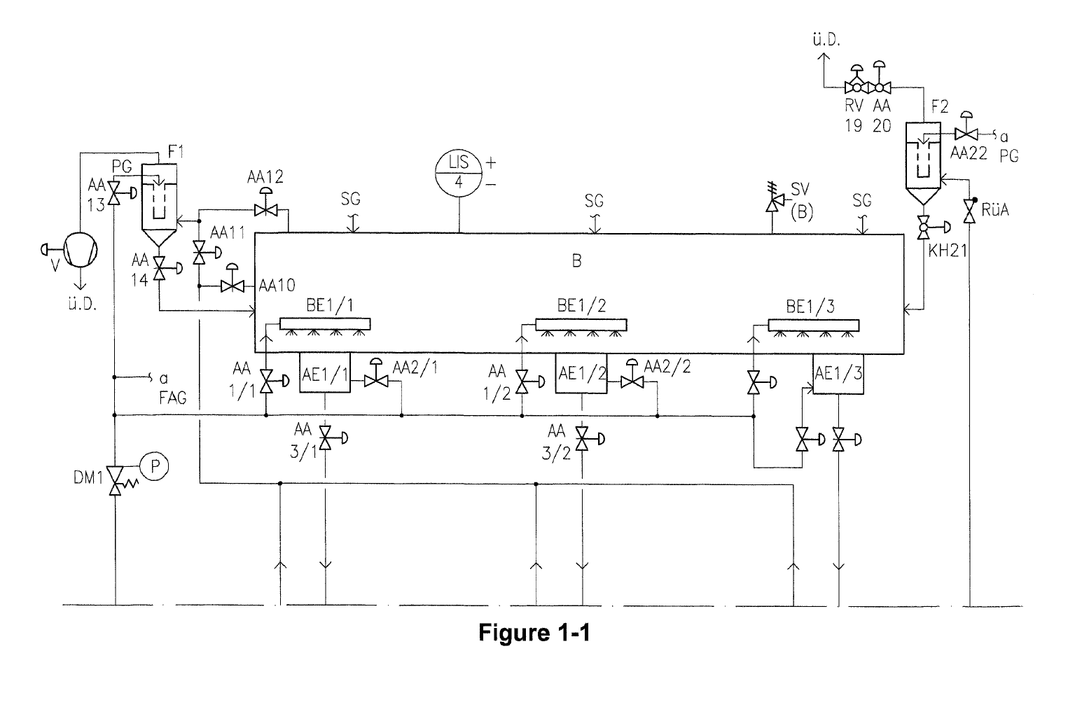

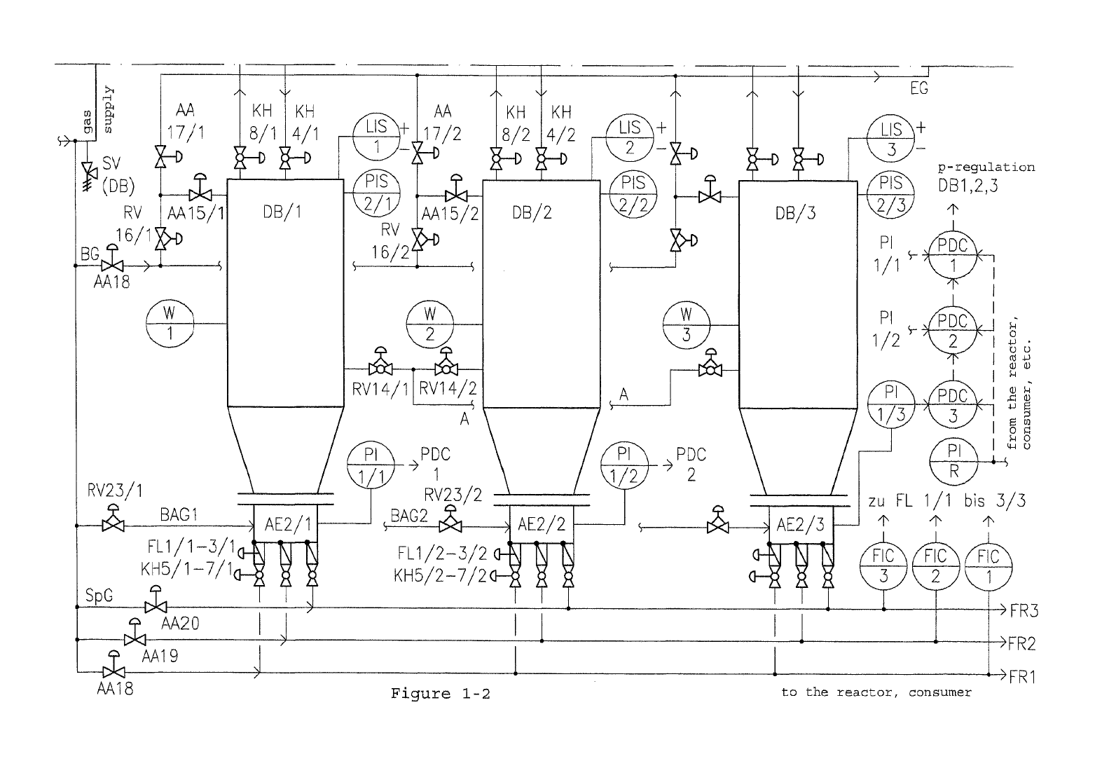

FIG. 1 shows a method flow chart of an embodiment of the dense phase conveying system according to the invention having a bunker as the supply device,

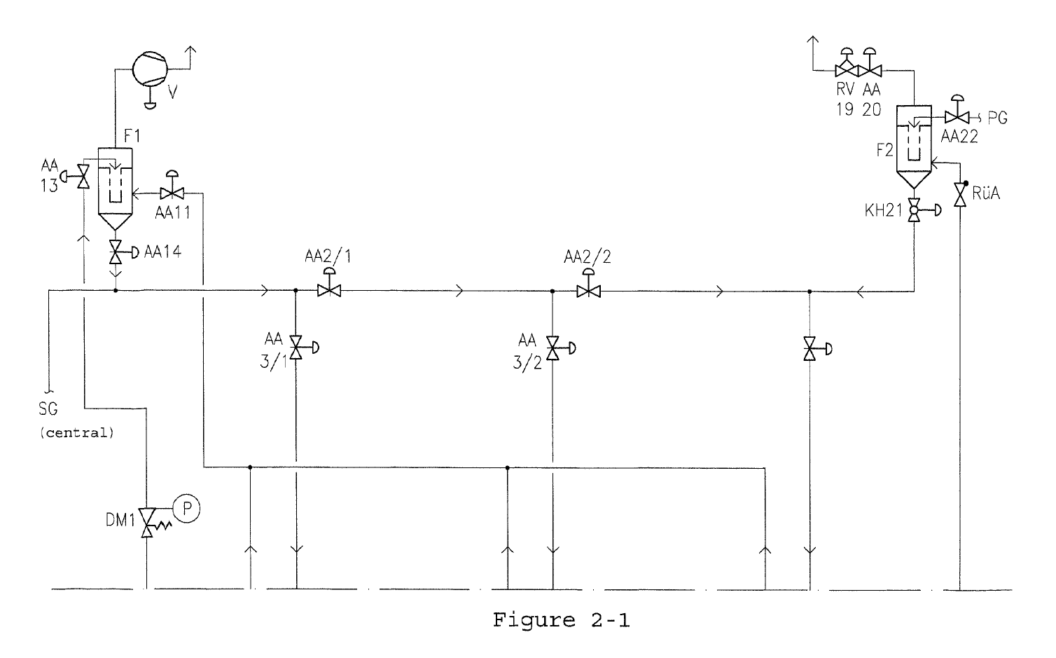

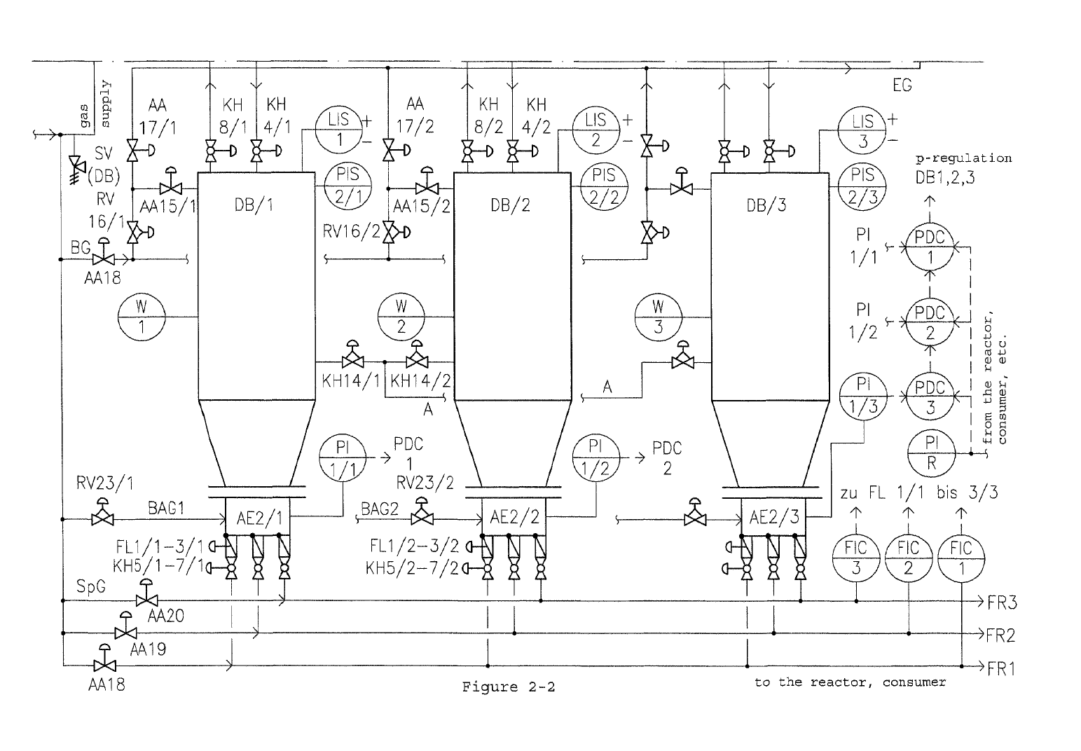

FIG. 2 shows a method flow chart of a further embodiment of the dense phase conveying system according to the invention having a central bulk material supply system,

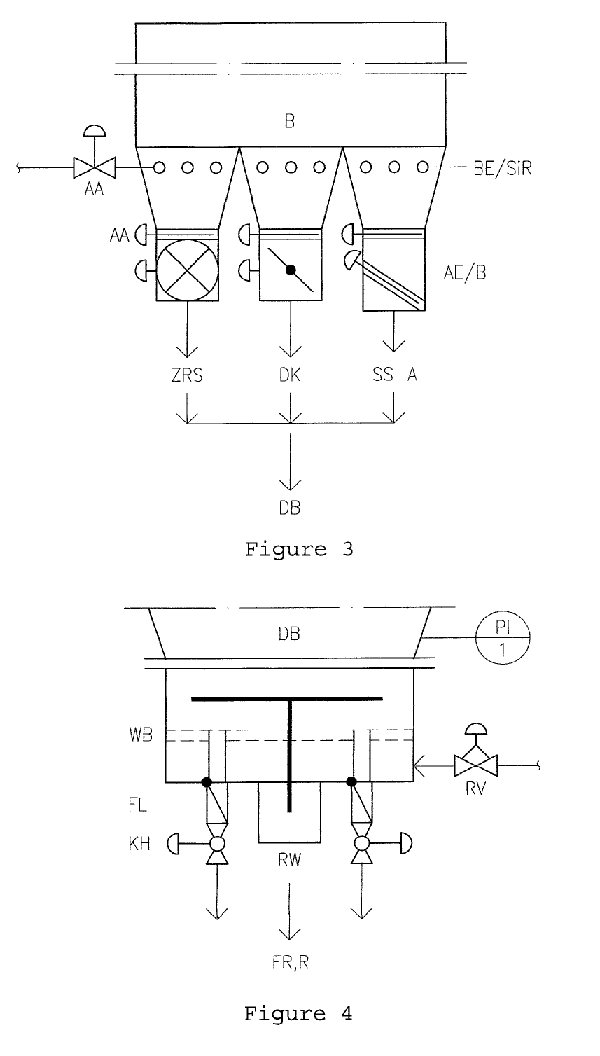

FIG. 3 shows a schematic detail view of the bunker from FIG. 1,

FIG. 4 shows a schematic detail view of a delivery device of a metering container of the metering system or dense phase conveying system according to the invention.

The device according to the invention fundamentally relates to a method and a device for the continuous, dosed supply of dusts of light, polydisperse particles into reactors and shaft furnaces at an arbitrary operating pressure, in particular in entrained flow reactors for pressurized gasification.

The light and polydisperse dusts have manifold shapes and a porous structure. Both effects have the result that the bulk density reaches values of 150-400 (450) kg/m³ and void volumes of up to 94% of the bulk volume. These light dusts no longer follow the gravity flow when flowing out of containers, but rather form wedges and only have a very low flowability.

Using the dense phase conveying system or metering system according to the invention, the continuous, dosed supply of the light, polydisperse dusts to consumer systems at arbitrary pressure is possible. The light dust steadily enters the bunker and the metering container, can be dosed uniformly distributed to the conveying tubes, the flow density of the dust conveying streams being nearly at values of the bulk density at least at the beginning of the conveying tubes.

The dust is supplied directly from a central repository (dryer, carbonization plant/degasser) or first to a bunker and then successively to multiple metering containers by means of pneumatic or mechanical conveyors. In the case of the supply into the bunker and in the case of the direct supply into the metering containers, the metering containers are brought to a partial vacuum in relation to the bunker or the central repository by means of a ventilator/suction filter, in order to exhaust the introduced carrier gas of the dust stream and cause the dust to settle (compact).

The dust of the bunker is conveyed successively into the metering containers according to the demand, the conveyance being forced by the partial vacuum in the respective metering container in relation to the bunker and by ventilation of the dust in the bunker using vault-like formed ventilation elements, for example, using porous sintered metal tubes. The delivery elements at the bunker cause a throttle effect; such bunker delivery elements can be, for example, a Y-type valve, a butterfly valve, or a rotary valve. Without the throttling at the delivery, the ventilation/delivery gas would not mix with the dust and would break through into the metering container uncharged as a simple, barely charged gas jet.

Only one of the metering containers always conveys to the consumer. For this purpose, at least one, but typically multiple, arbitrarily many conveying tubes extend from each metering container to the consumer. Upon reaching the fill level minimum of the first metering container, a next filled metering container, which is pressurized to operating pressure, is always ready for the sliding coupling to the still conveying metering container. The sliding coupling is performed by opening the closure devices, which may be ball valves, in the pressure equalization line of the two metering containers and by slowly opening the dust flow regulating units, for which, e.g. a FLUSOMET® regulating unit may be used at the exit of the metering container being coupled, and closing the dust flow regulating units at the same speed at the exit of the metering container to be decoupled. For the continuous supply, at least two metering containers are required, in the event of increasing metering performances, however, more than two can be coupled successively.

The conveyance of the light dust from the metering container to the consumer is assisted by a delivery device on the metering container, which comprises the following components: a swirl base for fluidization, a stirrer for bulk material homogenization and gas admixing, multiple dust flow regulating units for mass flow regulation in the individual conveying tubes and for equalizing the dust streams of the conveying tubes to one another, a regulating valve for the swirl gas quantity feed on the swirl base, and a pressure measuring point for the regulation of the metering container pressures during the pressurization, dosed conveyance, and depressurization.

The degrees of opening of the dust flow regulating unit upon the sliding coupling/decoupling of the metering containers are monitored using the mass flow measuring probes in the conveying tubes. The dust flow regulating units and the mass flow measuring probes together form controlled systems. A driving pressure differential is implemented as the drive of the dust stream via the dust flow regulating units as a function of the degree of opening and the pressure between metering container and consumer.

The swirl speed on the swirl base is set at 10 to 100% of the gas speed at the loosening point of the dusts handled here. This low speed is not to be exceeded, so as not to cause excessively strong swirling of the light, small particles. The gas speed at the loosening point of the dusts handled here is up to 0.01 m/s.

Dusts made of light, polydisperse particles have heretofore been unsuitable for continuous, dosed supply into reactors of arbitrary operating pressure, since they are easy to perfuse because of their large void volume and their particles have a strong tendency to float because of their low gross density. Furthermore, because of the low gravity pressure and because of the ability of the particles to form wedges, hardly any or no bulk material flow is to be achieved from delivery openings.

This is achieved by the method according to the invention using a system according to the invention, of which one embodiment is shown in FIG. 1. The system comprises a bunker B having the bunker delivery elements AE1/1 to AE1/3 and a metering system having the metering containers DB1, DB2, DB3, a ventilation of the bunker bulk fill being performed by means of the ventilation elements BE1/1 to BE1/3 above the delivery elements AE1/1 to AE1/3 and a vacuum being applied in the metering container to be filled, for example, the metering container DB/1 with open valves AA3/1, KH4/1, KH8/1, AA11, using the ventilator V, which is used as the pump device, for the purpose of generating a bulk material flow toward the metering container DB/1. The solid delivered with the exhaust gas from the metering container DB/1 is held back in the filter F1 and returned to the bunker B. If the metering container DB/1 reaches the maximum fill level LIS+1, the valves to the bunker B and to the filter F1 are closed, upon which the metering container DB/1 is pressurized at operating pressure PIS2/1, in that the shutoff valve AA15/1 and the regulating valve RV 16/1 in the pressurization gas line are opened and thus the metering container DB/1 is brought to the same pressure as the metering container DB/2, which is in the conveying state. By opening the ball valves KH 14/1 and KH 14/2 of the pressure equalization line between the metering containers DB/1 and DB/2, the metering container DB/1 can operate at equalized pressure until the metering container DB/2 is empty and the metering container DB/1 then takes over the metering supply to the reactor.

The mass flow regulation is performed via the variable differential pressure PDC between the metering container pressure PI1 of the first metering container DB/1 and the reactor pressure PIR, the supply of compensation gas BG being increased for mass flow increase and the exhaust of depressurization gas EG from the metering container DB via the pressure filter F2 being increased for mass flow reduction.

The continuous, dosed supply of the dust to the reactor is ensured by using the metering system according to the invention having at least two metering containers DB, however, a larger number can also be provided as a function of the reactor performance.

The light dust is ventilated, homogenized, and dosed according to the invention in the delivery elements AE2/1-3 of the metering containers DB/1-3 before entering the conveying tubes FR/1-3.

The at least two metering containers DB/1, DB/2 successively switch over to the operating modes alternately in accordance with the method as a function of reaching a maximum, minimum, or empty fill level LIS1, LIS2. While metering container DB/1 conveys in a dosed manner, the metering container DB/2 which has run empty is depressurized and brought to partial vacuum, filled with bulk material, and pressurized to operating pressure again.

Upon reaching the fill level minimum in the metering container DB/1, the sliding coupling of the metering container DB/2 to the metering container DB/1 is performed by opening the ball valves KH14/1, KH14/2 and the coupled dust flow regulation devices FI2/2 to FI3/2 of the common conveying tubes FR1, FR2, FR3. The sliding decoupling of the metering container DB/1 from the metering container DB/2 is then performed by closing the ball valves KH14/1, KH14/2 and the dust flow regulation devices FI2/2 to FI3/2 of the common conveying tubes FR1, FR2, FR3, upon which the metering container DB/2 takes over the dosed conveyance.

The steps of depressurization, partial vacuum generation, filling, and repressurization are now performed in the now empty metering container DB/1, which is then again operationally ready for retrieval.

Alternatively to the supply of the metering containers DB/1-3 from a bunker, the metering containers DB/1-3 can also be successively pneumatically or mechanically filled directly, as shown in FIG. 2, without a bunker from a central supply system. The carrier gas of the filling streams is also suctioned by the ventilator filter F1 out of the metering containers DB/1-3 here. Otherwise, the system in FIG. 2 corresponds to the system equipped with the bunker in FIG. 1.

The continuity of the dust streams to the reactor is thus also ensured here by the sliding coupling and decoupling of the metering containers DB/1-3, in that an equalization of the operating pressure between the two metering containers DB/1, DB/2 to be coupled is induced by opening the pressure equalization line and a closing speed and a closing amount of the dust flow regulation devices FI1/1-3/1 of the metering container DB/1 to be decoupled is always equal to an opening speed and an opening amount of the dust flow regulation devicees FI1/2-3/2 of the metering container DB/2 to be coupled and the dust stream in each conveying tube thus remains constant, which is monitored and controlled by the mass flow measuring system FIC1-3, which additionally influences the degree of opening of the dust flow regulation devices FI1/1-3/2.

The depressurization gas, which is let off from the metering containers DB in the event of excessively high operating pressures, can advantageously also be collected and recompressed, and used again as the operating gas BG, SpG, BAG1, if three or more metering containers DB/1, DB/2, DB/3 are installed.

A weighing system W1-W3 can be used to monitor the fill level of each metering container and to measure the total mass flow, which is made up of the sum of the individual mass flows in the conveying tubes.

In addition, if this is desired or necessary, a differing but defined mass flow can be set in each conveying tube FR1, FR2, FR3 by means of the dust flow regulation devices FI1/1-3/2 at the same time, in that the degree of opening of the dust flow regulation devices FI1/1-3/2 is changed, while the differential pressure PDC between metering container DB and reactor R is kept stable and constant.

A suitable dust flow regulation device is, for example, a FLUSOMET® regulating unit and has an adjustable flap having fine actuator, the free flow channel decreasing continuously downstream, being smooth and wear-resistant, and not offering any possibilities for forming wedges and swirling to the solid material stream.

The supply of pressurization and compensation gas to the metering container DB can be supplied horizontally, above the bulk fill as much as possible, so that it occurs diffusely distributed and swirling more intensive than 0.01 m/s and jet formation into the bulk material greater than 0.5 m/s are not generated.

The following description of the invention based on an example is used for better understanding and is not to restrict the scope of protection of the present invention to the described example.

According to FIG. 1 and FIG. 2, an entrained flow gasification reactor R having a pulverized fuel performance of approximately 400 MW can be charged with a total of 50 t/h of bio-coke via three identical conveying tubes FR1, FR2, FR3. At a bulk density of 250 kg/m³, the bio-coke stream therefore corresponds to a bulk material volume stream of 200 m³/h. The operating pressure PI-R in the reactor is 25 bar here, for example, and is always to be constant, i.e., PI-R is the reference pressure of the system.

The gross volume of the three metering containers DB/1, DB/2, DB/3 is 80 m³ each and the gross volume of the bunker B shown in FIG. 1 is 1200 m³. A reserve for approximately 6 hours of operation is therefore taken into consideration. In contrast, in FIG. 2, the supply of the metering containers DB/1, DB/2, DB/3 is performed directly from the central supply system SG without a bunker. The conveying tubes FR1, FR2, FR3 have a nominal width of DN 80 mm. The bio-coke having a particle size less than 500 μm, predominantly even less than 250 μm, is conveyed in the dense phase at speeds of at most 8 m/s.

The bio-coke is thermomechanically produced from renewable raw materials and is transported in FIG. 1 by means of pneumatic conveyance to the bunker B and distributed quasi-uniformly via multiple introduction points SG in the bunker B. While the dust settles in the bunker B, the inert conveying gas is suctioned away by the ventilator V and freed of dust particles in the filter F1.

The three metering containers DB/1, DB/2, DB/3 are set up directly below the bunker and are connected to declining fill lines, which can be shut off. The three metering containers DB/1, DB/2, DB/3 are filled successively. One metering container, e.g., DB/1, is connected to the reactor R and feeds the bio-coke via the three conveying tubes FR1, FR2, FR3 into the reactor R. The second metering container, e.g., DB/2, is filled and is pressurized to 25 bar, ready on demand for retrieval for coupling to the reactor R, when the minimum fill level is measured and signaled in the metering container DB/1 by the fill level measurement LIS1 or the scales W1. The third metering container DB/3 is empty, decoupled from the reactor R, depressurized, and can be filled and pressureized to 25 bar.

The filling of the empty metering containers DB/1, DB/2, DB/3 is executed automatically, in that the bio-coke is brought into the flowing state above the fill lines by means of the ventilation elements BE in the bunker B, as shown in FIG. 3, using fluidization gas, and a partial vacuum is generated in the metering container to be filled using the ventilator V (see FIG. 1), and the bio-coke is set into motion by opening the ball valve KH8 and the valves AA11, AA3, KH4. The gas suctioned off by the ventilator V is freed of dust in the filter F1. During the filling procedure, the throttle valve DK (AE) (see FIG. 3) is brought into the position so that the filling of the metering container can occur sufficiently rapidly and one metering container is always ready for coupling onto the reactor. The decoupling of the metering container from the bunker B begins upon signaling of the fill level maximum LIS1 or LIS2 or LIS3.

Upon reaching the fill level minimum, or shortly before the metering container DB1 runs empty, and upon notification of the minimum fill level LIS-/1 of the metering container DB1 feeding into the reactor, the weighing system W initiates the pressure equalization between the metering container DB1, which is going empty, and the filled metering container DB2, in that the ball valves KH14/1,2 open. Immediately after pressure equalization, in the filled metering container DB2, the delivery unit AE2/2 (a corresponding delivery unit AE is shown in greater detail in FIG. 4 having acceleration and delivery gas supply RV, having the swirl base WB, the stirrer RW, the dust flow regulating units FI, and the ball valves KH; the supply lines for acceleration and delivery gas BAG2 are shown in FIGS. 1 and 2) goes into operation or the dust flow regulating units FI1/2, FI2/2, FI3/2 and the ball valves KH5/2, KH6/2, KH7/2 open accordingly. Simultaneously with the opening of the elements of the filled metering container DB2, the same elements of the empty metering container DB 1 close, but in slow synchronous operating mode.

In order that the required bio-coke stream flows reliably, the conveyance streams in the conveying lines FR1, FR2, FR3 are monitored using mass flow measuring probes FIC1, FIC2, and FIC3. In the event of deviations from the target values, the conveyance streams are corrected by automatic adjustment of the degree of opening of the respective dust flow regulating units FI1, FI2, or FI3 of the corresponding metering metering container. With this regulation, if needed, different conveyance streams may also be set in the three conveying lines. However, the three outlets of each metering container in operation always feed into the three conveying lines.

While the dust flow regulating units FI are responsible for the individual tube regulation, the total conveyance stream from the metering container DB to the reactor R is regulated using the differential pressure PDC=PI1−PIR, which prevails between metering container and reactor and can be adjusted or tracked using the metering container pressure P1. If the total conveyance stream must be increased, then PI1 and therefore PDC are increased. The pressure increase is achieved in that more compensation gas BG, which corresponds to the pressurization gas, is supplied by further opening of the regulating valve RV16. If the total conveyance stream is to be decreased, then PI1 and therefore PDC are reduced. The pressure reduction in the metering container is performed by opening the depressurization gas regulating valve RV19 in conjunction with the opening of the valve pairs AA15, AA17 of a metering container. The depressurization gas is conducted via the pressure filter F2 for the purpose of keeping out dust. The overall pressurization and depressurization of the metering container is performed using the same valves and using the pressure meters PIS. The present total conveyance stream is calculated by means of chronologically analyzed weighing signals W1, W2, W3.

### LIST OF REFERENCE NUMERALS

SG dust, bulk material, supply device
B bunker, supply device
DB metering container
F filter
V ventilator, blower
BE ventilation element
AE delivery device
AA shutoff valve, slide
RV regulating valve
KH ball valve
RüA check valve
DM pressure reducer
SV safety valve, overpressure safety device
FI dust flow regulation device, measuring points:
   L: fill level, F: volume/mass flow,
   P: pressure, PD: differential pressure, W: weighing
DK butterfly valve for gas and solid material stream regulation
PG pulsed gas for filter cleaning
EG depressurization gas (pressure reduction)

BG pressurization/compensation gas (pressure elevation)
SpG flushing or conveyance gas
BAG acceleration/delivery gas
FAG fluidization/delivery gas
FR dust conveying tube
DK butterfly valve
ZRS rotary valve
SS-A Y-type valve
SiR sintered metal tube for bulk material ventilation
WB swirl base
RW stirrer
R reactor, consumer

1. Metering system for the steady, continuous, dosed supply of a bulk material in powder form made of light, polydisperse particles from a supply device into a plurality of conveying tubes (FR1, FR2, FR3) to a consumer arranged downstream, wherein
the metering system
comprises at least two metering containers each having a delivery device, the delivery device comprising a dust flow regulation device, which is assigned thereto and opens therein, for each of the conveying tubes, and
a mass flow measuring probe being arranged on each of the conveying tubes, which is coupled to the dust flow regulation device, which opens into the corresponding conveying tube,
has a pressure regulation device, which is coupled to pressure measuring devices arranged on the delivery devices, and which controls a metering container pressure at least as a function of a metering container fill level,
wherein a pump device is capable of being coupled to each of the metering containers, which provides a pressure in the metering container which is less than a pressure in the supply device.

2. Metering system according to claim 1,
wherein
two metering containers are connected to one another via a pressure equalization line, which has closing devices, wherein the closing devices are capable of being actuated at least as a function of the metering container pressure and/or the metering container fill level.

3. Metering system according to claim 2,
wherein
the closing devices, the dust flow regulation devices having assigned closure devices of the first metering container and the dust flow regulation devices having assigned closure devices of the second metering container are operatively coupled to one another via a control device, wherein a constant mass flow in each of the conveying tubes is provided as a function of the metering container fill level of the first metering container and the second metering container.

4. Metering system according to claim 1, wherein
the pressure regulation device is operatively coupled to
a plurality of regulation and shutoff valves in a pressurization gas line, a depressurization gas line, and a swirl gas line to the metering containers
the mass flow measuring probes,
a measuring device for a total mass flow and/or
a pressure measuring device of the consumer.

5. Metering system according to claim 1, wherein
the delivery device
comprises a swirl base and a stirring device arranged above the swirl base, the swirl gas line opening into the delivery device below the swirl base,
comprises the dust flow regulation devices having the assigned closure devices, and
is coupled to the pressure measuring device for the metering container pressure, and to a measuring device for a total mass flow.

6. Metering system according to claim 1, wherein
the dust flow regulation device has a smooth and wear-resistant flow channel having an adjustable flap having a fine actuator, the flow channel continuously decreasing in size downstream in the direction of the conveying tube.

7. Metering system according to claim 4, wherein
the pressurization gas line opens horizontally above a dust bulk fill present in the swirl base into the metering container in such a manner that a pressurization gas can be introduced diffusely distributed.

8. Metering system according to claim 1, wherein
the light, polydisperse particles have a void volume in a range up to 94% and a gross density of 200 to 800 kg/m³.

9. Dense phase conveying system for the steady, continuous, dosed supply of a bulk material in powder form made of light, polydisperse particles, comprising a supply device, a metering system, and conveying tubes, the supply device being connected to the metering system, from which the conveying tubes extend to a consumer,
wherein
the metering system is a metering system according to claim 1 made of at least two metering containers having assigned delivery devices.

10. Dense phase conveying system according to claim 9, wherein
the supply device
is a bunker, which comprises a ventilation element and bunker delivery elements in a number corresponding to a number of the metering containers, each bunker delivery element being connected via a filling line having a shutoff valve and a closure device to one of the metering containers, or
is a central supply system.

11. Dense phase conveying system according to claim 9, wherein
the dense phase conveying system comprises a ventilator device, which is connectable to the metering containers, the ventilator device being able to be actuated as a function of a metering container fill level.

12. Dense phase conveying system according to claim 11, wherein
the ventilator device provides a partial vacuum in the metering container in relation to a pressure in the supply device.

13. Method for the steady, continuous, dosed supply of a bulk material in powder form made of light, polydisperse particles using a dense phase conveying system according to claim 9 having a supply device, a metering system for the steady, continuous, dosed supply of a bulk material in powder form made of light, polydisperse particles from a supply device into a plurality of conveying tubes to a consumer arranged downstream, wherein the metering system comprises at least two metering containers each having a delivery device, the delivery device comprising a dust flow regulation device, which is assigned thereto and opens therein, for each of the conveying tubes, and a mass flow measuring probe being arranged on each of the conveying tubes, which is coupled to the dust flow regulation device, which opens into the corresponding conveying tube, has a pressure regulation device, which is coupled to pressure measuring devices arranged on the delivery devices, and which controls a metering container pressure at least as a function of a metering container fill level, wherein a pump device is capable of being coupled to each of the metering containers, which provides a pressure in the metering container which is less than a pressure in the supply device,
and having conveying tubes to a consumer arranged downstream, through coupled, adapted operation of the at least two metering containers of the metering system,
wherein the at least two metering containers, controlled as a function of the fill level,
at an empty level, a partial vacuum is applied thereto in relation to the supply device for filling with bulk material from the supply device,
at a fill level maximum, a pressurization gas is applied thereto to an operating pressure,
upon reaching a minimum fill level of a first metering container, while a second metering container having a fill level maximum is pressurized at operating pressure, are connected to one another in a sliding manner via the pressure equalization line, and the dust flow regulation devices of the first metering container adapting a conveyance in the conveying tubes and, coupled with opening of the dust flow regulation devices of the second metering container, end the conveyance in a manner controlled by the fill level, pressure, and mass flow.
